(19) United States
(12) Patent Application Publication
(10) Pub. No.: US 2008/0006671 A1
(43) Pub. Date: Jan. 10, 2008

(54) Piston assembly

(75) Inventor: Brad Yang, Tali City (TW)

Correspondence Address: Thomas E. Sisson;Jackson Walker, LLP, Suite 2100, 112 E. Pecan, San Antonio, TX, 78205, US

(73) Assignee: Testo Industry Corp.

(21) Appl. No.: 11/481,634

(22) Filed: Jul. 6, 2006

(51) Int. Cl. B25C 1/04

(52) U.S. Cl. 227/130

(57) ABSTRACT

A piston assembly for a staple gun has a piston head, a driving rod and a fastener. The piston head has a connecting post formed on and protruded axially from a top of the piston head and having two mounting blocks and an inserting recess. Each mounting block has two indents and two holding tabs. The inserting recess is defined between the inner sides of the mounting blocks, and the holding tabs extend into the inserting recess. The driving rod is connected securely with the piston head and has a body, a connecting segment and a driving segment. The connecting segment is mounted and held in the inserting recess and is engaged firmly with the holding tabs. The driving segment is formed on the upper end of the body to press staples out of the staple gun. The fastener is connected with the driving rod and the piston head.

### BACKGROUND OF THE INVENTION

1. Field of the Invention

The present invention relates to a piston assembly, and more particularly to a piston assembly for a staple gun and having an enhanced structure.

2. Description of Related Art

A conventional staple gun is used extensively with decorations, shoemaking and leatherwear and drives staples into objects by a conventional piston assembly (40) as shown in FIGS. 4 and 5.

A conventional piston assembly (40) is mounted movably in the staple gun, is used to push staples out of the staple gun and comprises a piston head (41), a driving rod (42) and a fastener (43). The driving rod (42) is mounted with the piston head (41) and is used to press and shoot staples out of the staple gun. The fastener (43) is extended through the piston head (41) and the driving rod (42) to connect the driving rod (42) with the piston head (41).

However, the conventional piston assembly (40) has the following shortcomings.

1. Because the staple is ejected from the staple gun at a high speed, the driving rod (42) is easily broken at the connecting segment with the piston head (41) due to the huge ejecting force. In addition, the broken driving pin (42) may destroy internal elements of the staple gun.

2. The broken piston assembly (40) increases the economical burden to the user.

To overcome the shortcomings, the present invention provides a piston assembly to mitigate or obviate the aforementioned problems.

### SUMMARY OF THE INVENTION

The main objective of the present invention is to provide a piston assembly that has an enhanced structure.

The piston assembly for a staple gun has a piston head, a driving rod and a fastener. The piston head has a connecting post formed on and protruded axially from a top of the piston head and having two mounting blocks and an inserting recess. Each mounting block has two indents and two holding tabs. The inserting recess is defined between the inner sides of the mounting blocks, and the holding tabs extend into the inserting recess. The driving rod is connected securely with the piston head and has a body, a connecting segment and a driving segment. The connecting segment is formed on a lower end of the body, is mounted and held in the inserting recess and is engaged firmly with the holding tabs. The driving segment is formed on the upper end of the body to press and shoot staples out of a staple gun. The fastener is connected with the driving rod and the piston head.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a piston assembly in accordance with the present invention;

FIG. 2 is an exploded perspective view of the piston assembly in FIG. 1;

FIG. 3 is an enlarged perspective view of the piston assembly in FIG. 1;

FIG. 4 is a perspective view of a conventional piston assembly in accordance with the prior art; and

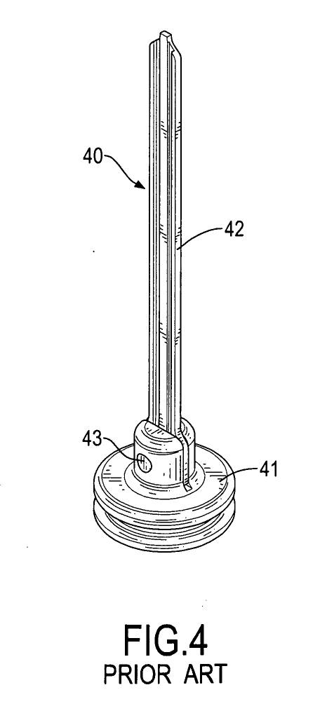

FIG. 5 is an enlarged perspective view of the conventional piston assembly in FIG. 4.

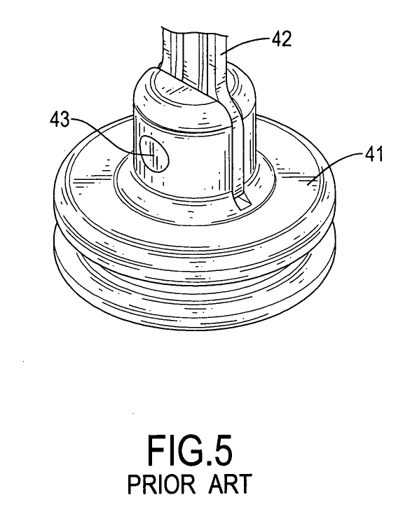

### DETAILED DESCRIPTION OF THE PREFERRED EMBODIMENT

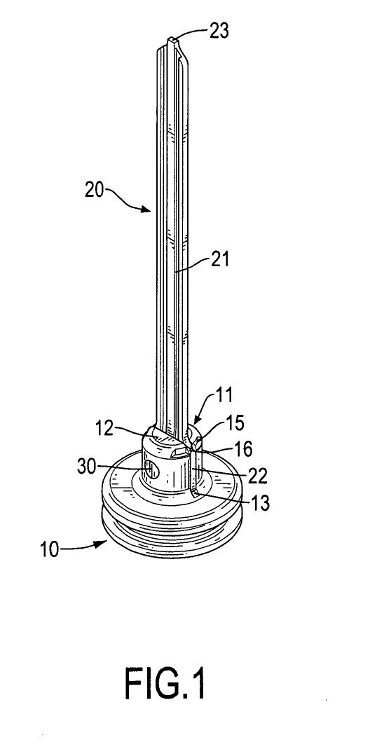

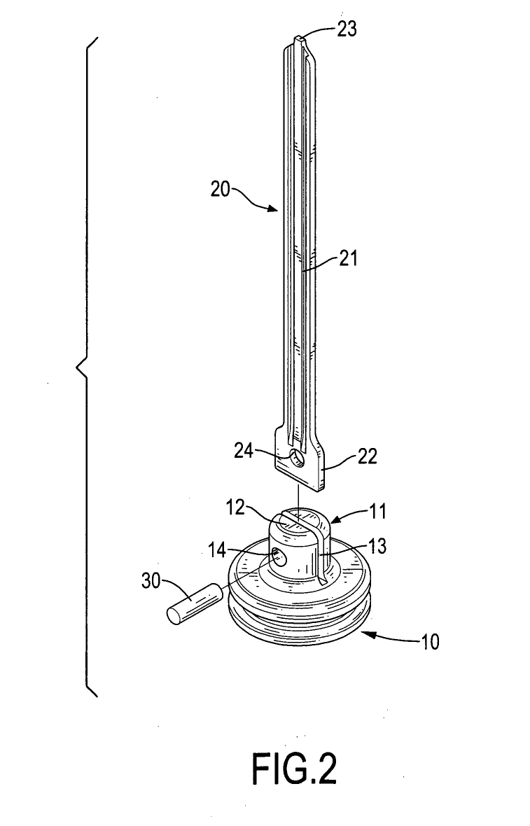

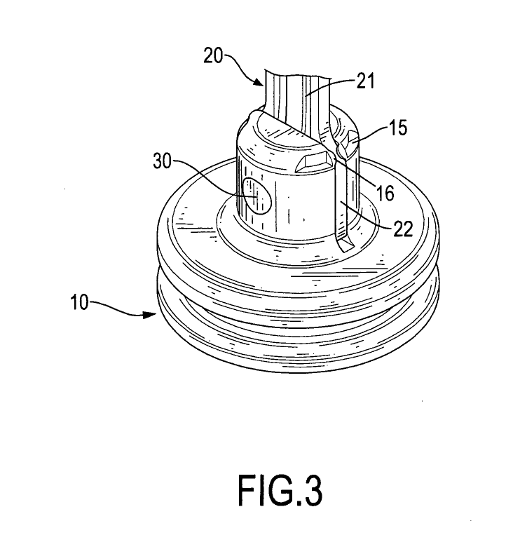

With reference to FIGS. 1 to 3, a piston assembly for a staple gun in accordance with the present invention comprises a piston head (10), a driving rod (20) and a fastener (30).

The piston head (10) may be circular and has a top and a connecting post (11). The connecting post (11) is formed on and protruded axially from the top of the piston head (10) and has two mounting blocks (12), an inserting recess (13) and two through holes (14).

The mounting blocks (12) may be semicircular and are formed on the top of the piston head (10), and each mounting block (12) has an inner side, an outer side, an upper edge, two indents (15) and two holding tabs (16). The inner sides of the mounting blocks ( 12) are faced to each other. The indents (15) are defined in the upper edge of the mounting block (12). The holding tabs (16) are respectively formed on and protruded out from the indents (15).

The inserting recess (13) is defined between the inner sides of the mounting blocks (12), and the holding tabs (15) extend into the inserting recess (13). The through holes (14) are formed respectively through the mounting blocks (12) from the outer side to the inner side, align with each other and communicate with the inserting recess (13).

The driving rod (20) is connected securely with the piston head (10) and has a body (21), a connecting segment (22) and a driving segment (23). The body (21) of the driving rod (20) has an upper end and a lower end.

The connecting segment (22) may be flat, is formed in the lower end of the body (20), is mounted and held in the inserting recess (13), is engaged firmly with the holding tabs (16) of the mounting blocks (12) and has an optional mounting hole (24). The mounting hole (24) is formed through the connecting segment (22) and aligns with the through holes (14) of the mounting blocks (12).

The driving segment (23) is formed on the upper end of the body (21), is used to press and shoot staples out of a staple gun.

The fastener (30) is connected with the driving rod (20) and the piston head (10). The fastener (30) is extended through the through holes (14) of the mounting blocks (12) and the mounting hole (24) of the connecting segment (22) to attach the driving rod (20) with the piston head (10).

The piston assembly as described has the following advantages.

1. The driving rod (20) is firmly connected with the piston head (10) with the holding tabs (16) engaging with the connecting segment (22) of the driving rod (20). Therefore, the piston assembly has a reinforced structural strength to bear a huge ejecting force of the staple gun and is kept from being broken down. Consequently, the useful life of the piston assembly is prolonged.

2. In addition, because the driving rod (20) is not easily broken, the internal elements of the staple gun can be kept from being damaged.

3. The piston assembly is convenient in use and decreases the economical burden of the user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A piston assembly for a staple gun comprising:
a piston head having
a top; and
a connecting post being formed on and protruded axially from the top of the piston head and having
two mounting blocks being formed on the top of the piston head and each mounting block having
an inner side faced to the inner side of the other mounting block;
an outer side;
an upper edge;
two indents being defined in the upper edge of the mounting block; and
two holding tabs being formed on and protruded out from the indents; and
an inserting recess being defined between the inner sides of the mounting blocks; and
a driving rod being connected securely with the piston head and having
a body having
an upper end; and
a lower end;
a connecting segment being flat, being formed on the lower end of the body, being mounted and held in the inserting recess, and having two curved rims being defined between the connecting-segment-and-the body and engaging firmly the holding tabs. wherein the holding tabs extend into the inserting recess; and
a driving segment being formed on the upper end of the body to be adapted to press and shoot staples out of the staple gun; and
a fastener being connected with the driving rod and the piston head.

2. The piston assembly as claimed in claim 1, wherein
the connecting post further has two through holes formed respectively through the mounting blocks from the outer side to the inner side, aligning with each other and communicating with the inserting recess;
the connecting segment further has a mounting hole formed through the connecting segment and aligning with the through holes of the mounting blocks; and
the fastener extends through the through holes of the mounting blocks and the mounting hole of the connecting segment to attach the driving rod with the piston head.

3. The piston assembly as claimed in claim 1, wherein the piston head is circular.

4. The piston assembly as claimed in claim 1, wherein the mounting blocks are semicircular.

5. (canceled)

6. The piston assembly as claimed in claim 2, wherein the piston head is circular.

7. The piston assembly as claimed in claim 6, wherein the mounting blocks are semicircular.

8. (canceled)
